(19) United States
(12) Patent Application Publication
(10) Pub. No.: US 2024/0119517 A1
(43) Pub. Date: Apr. 11, 2024

(54) ARTIFICIAL INTELLIGENCE BASED METHODS AND SYSTEMS FOR PREDICTING CREDITWORTHINESS OF MERCHANTS

(71) Applicant: MASTERCARD INTERNATIONAL INCORPORATED, PURCHASE, NY (US)

(72) Inventors: Ayush AGARWAL, Roorkee (IN); Maneet SINGH, New Delhi (IN); Bhanupriya PEGU, Dhemaji (IN); Shivshankar Anand REDDY, Navi Mumbai (IN)

(21) Appl. No.: 18/062,573

(22) Filed: Dec. 6, 2022

(30) Foreign Application Priority Data
Oct. 5, 2022 (IN) 202241057097

(51) Int. Cl. G06Q 40/02

(52) U.S. Cl. CPC G06Q 40/02

(57) ABSTRACT

Embodiments provide methods and systems for determination of creditworthiness of a first merchant. The method performed by a server system includes receiving invoice data of the first merchant from a merchant invoice database. The invoice data includes information of past invoices associated with the first merchant. Additionally, the method includes generating a homogeneous graph based, at least in part, on the information of past invoices. Further, the method includes determining a feature representation of the first merchant based on data features associated with the first merchant in the homogenous graph. Furthermore, the method includes calculating a credit risk score for the first merchant based on the credit risk score model.

### CROSS-REFERENCE TO RELATED APPLICATION

This application claims priority to India Patent Application No. 202241057097 filed Oct. 5, 2022, entitled “Artificial Intelligence Based Methods and Systems for Predicting Creditworthiness of Merchants”, the entirety of which is incorporated herein by reference.

### TECHNICAL FIELD

The present disclosure relates to artificial intelligence processing systems and, more particularly to, electronic methods and complex processing systems for predicting the creditworthiness of merchants such as small and medium-sized merchants.

### BACKGROUND

Small and medium-sized enterprises (SMEs) play a vital role in the modern economy. For example, the Ministry of Micro, Small, and Medium Enterprises (MSMEs) accounts for around 30% of India's Gross domestic product (GDP). SMEs generally need financial services (such as lines of credit, lending, credit card, etc.) for their business growth. According to statistics, around 29% of SMEs fail because they run out of capital. Further, around 48% of SMEs have their overall financing needs met. It is to be noted that only around 10-15% of SMEs receive formal credit and around 80% of SMEs are either under-financed or financed informally.

Generally, SMEs find it difficult to obtain credit from banks since SMEs generally do not have enough collateral and/or cash flow. This is because there is a lack of appetite among banks to provide funding and support to SME businesses as the rate of default in loans sanctioned to SMEs is much higher than that for large-scale businesses. Conventionally, a credit risk score is generally calculated for an entity (e.g., person, business, etc.) to determine the creditworthiness of the entity. In particular, a credit risk score is calculated for an entity to determine whether the entity will be able to repay the sanctioned credit amount. However, there is no proper credit risk score to evaluate the financial performance of any SME since most of the conventional solutions require formal data and/or credit-related attributes to assess the financial condition of a company (e.g., SME). Moreover, credit-related attributes of SMEs are difficult to acquire sufficiently as SMEs suffer from data deficiency problems i.e., enough data (e.g., purchase data, transaction data, etc.) is not available for a new SME.

In view of the above discussion, there exists a technological need for an artificial intelligence-based method for predicting creditworthiness of merchants especially the SMEs.

### SUMMARY

Various embodiments of the present disclosure provide artificial intelligence-based methods and systems for determination of creditworthiness of merchants particularly the small and medium-sized merchants.

In an embodiment, a computer-implemented method is disclosed. The method includes receiving, by a server system, invoice data of a first merchant from a merchant invoice database. The invoice data includes information of past invoices associated with the first merchant. In addition, the method includes generating, by the server system, a homogeneous graph based, at least in part, on the information of past invoices. The homogenous graph includes a plurality of nodes representing the first merchant and a plurality of second merchants, and edges representing interactions performed among the first merchant and the plurality of second merchants. Further, the method includes determining, by the server system, a feature representation of the first merchant based, at least in part, on data features associated with the first merchant in the homogenous graph. Furthermore, the method includes determining, by the server system, a credit risk score for the first merchant based, at least in part, on a credit risk model. The credit risk score is indicative of creditworthiness of the first merchant.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some embodiments of the present disclosure;

FIG. 2 illustrates a simplified block diagram of a server system, in accordance with an embodiment of the present disclosure;

FIG. 3 is an example representation of communication data flow to determine creditworthiness of a first merchant, in accordance with an embodiment of the present disclosure;

FIG. 4 is a block diagram representation of the calculation of a first credit risk score from graphical features, in accordance with an embodiment of the present disclosure;

FIG. 5 is a block diagram representation of data exchange between a plurality of second merchants, in accordance with an embodiment of the present disclosure;

FIG. 6 represents a flow chart of a method for determining the creditworthiness of the first merchant, in accordance with an embodiment of the present disclosure;

FIG. 7 illustrates a flow diagram depicting a method for calculating a credit risk score for the first merchant, in accordance with an embodiment of the present disclosure; and

FIG. 8 is a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through the use of cash substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as Mastercard®.

The term “merchant”, used throughout the description generally refers to a buyer, a seller, a retailer, a purchase location, a sell location, an organization, or any other entity that is in the business of buying goods, selling goods, or providing services, and it can refer to either a single business location or a chain of business locations of the same entity.

The terms “credit loan provider” or “lending institution” may refer to an individual or entity that engages in underwriting services, loan services, financial advising, fundraising services, and/or other banking services for merchants. For example, a credit loan provider may review (e.g., approve, deny, and the like) and provide loans to merchants and charge an interest rate on the loaned amount. As used herein, the term “credit loan provider” may also refer to one or more computer systems operated by or on behalf of the merchant bank, such as a server computer executing one or more software applications. For example, a merchant bank system may include one or more loan processing processors for reviewing loan requests from merchants.

Overview

Various embodiments of the present disclosure provide methods, systems electronic devices, and computer program products for determining the creditworthiness of a small and medium-sized merchant (e.g., Small and medium-sized enterprise (SME)). SME may also be referred to as a merchant. In addition, the merchant may correspond to a buyer or a seller. More specifically, embodiments of the present disclosure disclose a method to determine whether a merchant (hereinafter referred to as the first merchant) will be able to re-pay obtained credit from a financial institution (e.g., a bank or credit loan provider) based on the purchase history of purchases made between other SMEs (hereinafter referred to as a plurality of second merchants) in a similar supply chain.

As stated above, conventional solutions require credit-related attributes to assess the financial condition of a new merchant. However, it is difficult to acquire sufficient credit-related attributes corresponding to the new merchant as it suffers from data deficiency problems.

To overcome the above-stated problem or limitation, the present disclosure describes a server system that is configured to determine the creditworthiness of the first merchant (i.e., new merchant or existing merchant). More specifically, the server system is configured to calculate a credit risk score for the first merchant. The credit risk score is indicative of the creditworthiness of the first merchant i.e., the credit risk score helps in determining whether the first merchant will be able to repay the requested credit loan amount.

At least one of the technical problems addressed by the present disclosure includes the determination of credit risk scores for relatively new merchants with no existing credit risk score or a digital financial trail. The present disclosure utilizes invoices of a new merchant to generate its neighborhood graph based on past orders. The present disclosure utilizes a homogenous graph to generate an embedding capturing the reliability and/or quality of the merchant based on its past interactions with other merchants. The present disclosure focuses on combining conventional merchant data with aggregated graph-based embeddings for merchant credit prediction.

The server system includes at least a processor and a memory. In one non-limiting example, the server system is a payment server. The server system is configured to receive invoice data of a first merchant (e.g., new merchant) from a merchant invoice database. The invoice data includes information of past invoices associated with the first merchant. The first merchant belongs to a supply chain out of one or more supply chains. It is to be noted that the first merchant can be a new merchant or an existing merchant.

The server system is then configured to generate a homogeneous graph based, at least in part, on the information of past invoices. The homogenous graph includes a plurality of nodes representing the first merchant and a plurality of second merchants, and edges representing interactions performed among the first merchant and the plurality of second merchants.

In one implementation, the server system is configured to identify the supply chain of the first merchant based, at least in part, on the information of past invoices. Moreover, the server system is configured to select the plurality of second merchants that have interacted with the first merchant based, at least in part, on the identified supply chain of the first merchant.

The server system is configured to determine a feature representation of the first merchant based, at least in part, on data features associated with the first merchant in the homogenous graph. The data features associated with the first merchant include graphical features and merchant-specific transaction features associated with the first merchant.

The graphical features include out-degree features capturing the network of the first merchant with the plurality of second merchants, out-degree features capturing dollar amount of transactions with the network of the plurality of second merchants, out-degree features capturing on-time payments of the first merchant with the plurality of second merchants, and two hop features capturing network of the first merchant with the plurality of second merchants.

Furthermore, the server system is configured to determine a credit risk score for the first merchant based, at least in part, on the credit risk model. The credit risk score is indicative of the creditworthiness of the first merchant. In one non-limiting example, the credit risk model is a classification model.

In other words, the server system initially receives a loan request from the first merchant. The loan request is received via an application programming interface (API). The server system is then configured to implement the credit risk model for determining the credit risk score for the first merchant. Further, the server system is configured to transmit a notification to the credit loan provider. The notification includes the credit risk score of the first merchant.

Various embodiments of the present disclosure offer multiple advantages and technical effects. For instance, the present disclosure determines the creditworthiness of a relatively new merchant. The present disclosure can be used to score merchants without a digital financial trail. The present disclosure can be utilized by financial institutions (such as banks or non-banking financial corporations (NBFCs)) as an additional metric to evaluate the creditworthiness of a new SME. The present disclosure can be utilized to determine the creditworthiness of merchants without any pre-established credit risk scores.

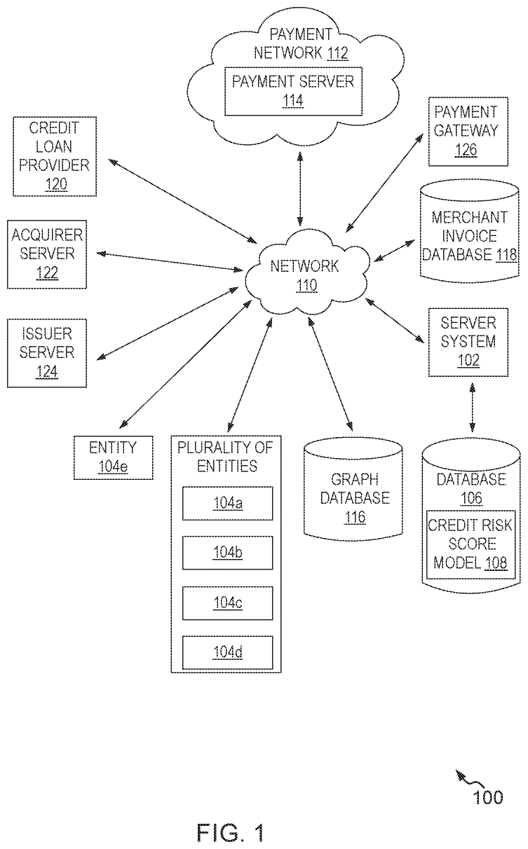

Various example embodiments of the present disclosure are described hereinafter with reference to FIGS. 1 to 8.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining the creditworthiness of small merchants, etc. The environment 100 generally includes a plurality of entities, including a server system 102, a plurality of second merchants 104a, 104b, 104c, and 104d (hereinafter, collectively, may also be referred to as second merchants 104a-104d), a first merchant 104e, a payment network 112 including a payment server 114, a graph database 116, a merchant invoice database 118, a credit loan provider 120, and a payment gateway 126, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, future communication protocols, or any combination thereof. For example, the network 110 may include multiple different networks, such as a private network made accessible by the network 110 to the server system 102, and a public network (e.g., the Internet, etc.).

In one example, the plurality of second merchants 104a-104d may be a micro or small enterprise (MSE), having less than a threshold amount (e.g., less than $1M, etc.) in sales per year initiated using electronic payments (e.g., debit and/or credit card transactions). The second merchants 104a-104d may be a distributor or a retail merchant at a particular geographic location. In one example, the merchant 104a may ship products to the merchant 104b which sells the products to the merchant 104c, the merchant 104d and the first merchant 104e.

In one embodiment, each merchant (e.g., the second merchants 104a-104d) may be associated with either an acquirer server 122 or an issuer server 124. In one embodiment, the acquirer server 122 is associated with a financial institution (e.g., a bank) that processes financial transactions. This can be an institution that facilitates the processing of payment transactions for physical stores, or merchants, or an institution that owns platforms that make online purchases or purchases made via software applications possible (e.g., shopping cart platform providers and in-app payment processing providers). The terms “acquirer”, “acquiring bank”, “acquirer bank” or “acquirer server” will be used interchangeably herein.

In one embodiment, the issuer server 124 is associated with a financial institution normally called an “issuer bank” or “issuing bank” or simply “issuer”, in which a cardholder may have a payment account, (which also issues a payment card, such as a credit card or a debit card), and provides microfinance banking services (e.g., payment transaction using credit/debit cards) for processing electronic payment transactions, to the cardholder.

In one example, the second merchants 104a-104d may involve in business-to-business (B2B) transactions with each other. In general, B2B transactions refer to commercial transactions that occur between businesses, such as those involving a manufacturer and a wholesaler or retailer. In an example, the merchant 104a may be involved in a B2B transaction with the merchant 104c. In one embodiment, the plurality of second merchants 104a-104d may belong to a specific supply chain or sector. Generally, a supply chain is the network of all the individuals, resources, organizations, technologies, and activities involved in the creation and sale of a product.

The first merchant 104e herein corresponds to a new merchant (e.g., new business, a new organization, new institution, etc.) that belongs to a similar supply chain as that of the plurality of second merchants 104a-104d. More specifically, the second merchants 104a-104d and the first merchant 104e belong to a similar supply chain. In some cases, the supply chains for different industries may overlap with each other, and therefore, the second merchants 104a-104d and the first merchant 104e may belong to one or more supply chains.

In an example, the plurality of second merchants 104a-104d may correspond to rubber companies that mainly deal with rubber supply and thus, belong to the rubber supply chain. In another example, the second merchants 104a-104d may correspond to companies involved in the manufacturing and supply of semiconductors and thus, belong to the semiconductor supply chain.

The credit loan provider 120 refers to a financial institution normally called a “credit lending company” in which an individual or an institution can request a credit loan. More specifically, the first merchant 104e requests a credit loan from the credit loan provider 120. In one example, the first merchant 104e requests the credit loan provider 120 to deposit the credit loan amount in a payment account of the first merchant 104e. To approve the credit loan request of the first merchant 104e, the credit loan provider 120 may ask the first merchant 104e to submit its invoice data with the credit loan provider 120. The invoice data may include past invoices of the first merchant 104e with other merchants (other merchants may or may not include the plurality of second merchants 104a-104d). The credit loan provider 120 may then perform internal screening to check the creditworthiness of the first merchant 104e. In one embodiment, the credit loan provider 120 may request the server system 102 to determine the creditworthiness of the first merchant 104e i.e., to determine whether the first merchant 104e will be able to repay the credit loan amount and not default. In one implementation, the credit loan provider 120 may request the server system 102 via the application programming interface (API).

The server system 102 is configured to perform one or more of the operations described herein. The server system 102 is configured to determine the creditworthiness of the first merchant 104e. More specifically, the server system 102 is configured to determine whether the first merchant 104e will be able to repay the credit loan in the future. The server system 102 is a separate part of the environment 100 and may operate apart from (but still in communication with, for example, via the network 110), the plurality of second merchants 104a-104d, and any third-party external servers (to access data to perform the various operations described herein). However, in other embodiments, the server system 102 may be incorporated, in whole or in part, into one or more parts of the environment 100, for example, the payment server 114. In addition, the server system 102 should be understood to be embodied in at least one computing device in communication with the network 110, which may be specifically configured, via executable instructions, to perform as described herein, and/or embodied in at least one non-transitory computer-readable media.

In one implementation, the server system 102 is configured to run or implement the credit risk score model 108 to calculate a credit risk score for the first merchant 104e. In one implementation, the server system 102 calls the credit risk score model 108 via API. The credit risk score model 108 is configured to output a probability score or value indicating the likelihood that the first merchant 104e may default in the future. In another embodiment, the credit risk score model 108 is configured to output a binary value indicating the likelihood that the first merchant 104e may default in the future. For example, a binary value of 0 may indicate that the merchant 104e shall not default in the future, whereas a binary value of 1 may indicate that the first merchant 104e can default in the future.

Initially, the server system 102 is configured to access or receive historical business data (or invoice data) associated with the first merchant 104e from the merchant invoice database 118. The business data may include information of historical invoices associated with the first merchant 104e. Generally, an invoice is a time-stamped commercial document that itemizes and records a transaction between a buyer and a seller. The server system 102 is then configured to generate a homogeneous graph based on the historical business data (i.e., the invoice data). The homogeneous graph includes a plurality of nodes representing the second merchants 104a-104d and edges representing interactions performed among the first merchant 104e and the second merchants 104a-104d. In one implementation, the second merchants 104a-104d belong to a single supply chain. More specifically, the server system 102 is configured to identify the supply chain of the first merchant 104e based, at least in part, on the historical business data and then selects the second merchants 104a-104d based on the identified supply chain. The server system 102 is then configured to define the homogeneous graph.

In one example, the homogeneous graph may include graph embeddings of the second merchants 104a-104d along with the embeddings of the first merchant 104e. In one implementation, the homogeneous graph is generated based, at least in part, on a neighborhood aggregation algorithm.

In one example, the server system 102 may utilize the neighborhood aggregation algorithm to extract information from neighboring nodes of a merchant node in the homogeneous graph. More specifically, the server system 102 extracts information from the merchant node (i.e., central node) and its neighboring nodes. The server system 102 is further configured to utilize this information to determine a first credit risk score for the first merchant 104e. The first credit risk score is a score indicative of the likelihood that the first merchant 104e can default in the future.

Furthermore, the server system 102 is configured to utilize the historical business data (i.e., invoice data) of the first merchant 104e to calculate a second credit risk score for the first merchant 104e. The second credit risk score is a score indicative of the likelihood that the first merchant 104e can default in the future. Moreover, the server system 102 is configured to calculate a weighted average of the first credit risk score and the second credit risk score as the credit risk score for the first merchant 104e. The credit risk score is a final credit risk score indicative of the likelihood that the first merchant 104e can default in the future. It is to be noted that the credit risk score is the final credit risk score that is calculated based on the first credit risk score and the second credit risk score, and therefore, the credit risk score is used as the final output for the server system 102 to determine the creditworthiness of the first merchant 104e.

The server system 102 may also transmit a notification to the credit loan provider 120. In an embodiment, the server system 102 may send a probability value in the notification indicating the percentage of likelihood that the first merchant 104e can default in the future. In an example, the server system 102 sends a notification that there is a 73% chance or probability that the first merchant 104e can default in the future. In another embodiment, the server system 102 may send a binary value in the notification indicating the likelihood that the first merchant 104e can default in the future. In an example, if the credit risk score is calculated to be 0, the server system 102 sends a notification that the first merchant 104e shall not default in the future. In another example, if the credit risk score is calculated to be 1, the server system 102 sends a notification that the first merchant 104e can default in the future.

The database 106 may provide storage location to the credit risk score model 108. In one implementation, the database 106 provides storage location to the metadata used during the implementation of the credit risk score model 108. The graph database 116 provides storage location to graphical features of the second merchants 104a-104d in the homogeneous graph. More specifically, the graph database 116 provides storage location to the homogenous graph. Additionally, the graph database 116 stores metadata associated with the homogenous graph. In some implementations, the merchant invoice database 118 provides storage location to the transaction data or business data (i.e., invoice data or invoices) associated with the second merchants 104a-104d or the first merchant 104e.

In an implementation, the database 106 can be accessed, viewed, altered, or deleted with the facilitation of either a database management system (DBMS) or a relational database management system (RDBMS). In an implementation, the graph database 116 can be accessed, viewed, altered, or deleted with the facilitation of either a DBMS or an RDBMS. In an implementation, the merchant invoice database 118 can be accessed, viewed, altered, or deleted with the facilitation of either a DBMS or an RDBMS.

The payment gateway 126 is a merchant service or technology provided by a service provider to authorize or accept card purchases (e.g., credit card, debit card, payment card, etc.) or direct payments for e-businesses, online retailers, and the like. In one implementation, the payment gateway 126 facilitates the collection of payments from card purchases or direct payments for e-businesses, online retailers, and the like. In one example, a merchant (e.g., the second merchants 104a-104d) who does not have a direct merchant account with the bank may use the payment gateway 126 to process payments.

In one implementation, the second merchants 104a-104d can perform payment transactions with each other via the payment gateway 126. The payment gateway 126 enables a platform for the plurality of second merchants 104a-104d to interact with each other. The second merchants 104a-104d can perform B2B payment transactions with each other via the payment gateway 126. In one implementation, the second merchants 104a-104d can perform business transactions with each other via the payment gateway 126. For example, the merchant 104a can exchange invoices with the merchant 104c via the payment gateway 126.

In one embodiment, the payment network 112 may be used by the payment card issuing authorities as a payment interchange network. The payment network 112 may include a plurality of payment servers such as the payment server 114. Examples of payment interchange networks include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 is provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

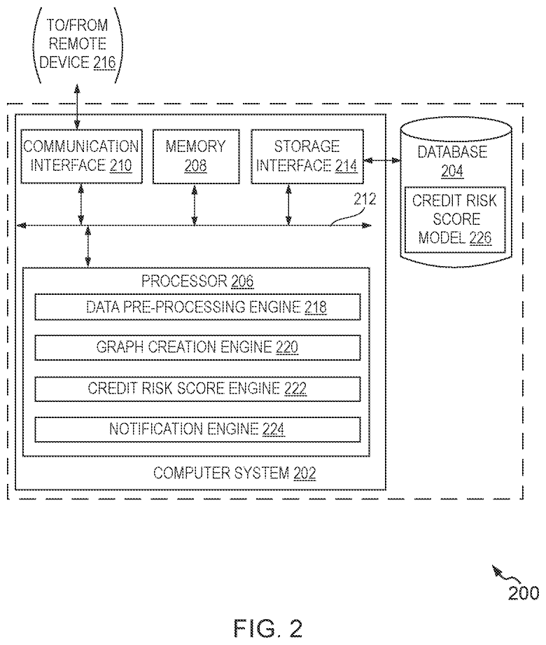

Referring now to FIG. 2, a simplified block diagram of a server system 200 is shown, in accordance with an embodiment of the present disclosure. The server system 200 is identical to the server system 102 of FIG. 1. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store a credit risk score model 226. The credit risk score model 226 is identical to the credit risk score model 108 of FIG. 1.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as the payment server 114 or communicating with any entity connected to the network 110. In one embodiment, the processor 206 is configured to receive invoice data of the first merchant 104e from the merchant invoice database 118.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 218, a graph creation engine 220, a credit risk score engine 222, and a notification engine 224. It should be noted that components, described herein, such as the data pre-processing engine 218, the graph creation engine 220, the credit risk score engine 222, and the notification engine 224 can be configured in a variety of ways, including electronic circuitries, digital arithmetic and logic blocks, and memory systems in combination with software, firmware, and embedded technologies. In one embodiment, the processor 206 is configured to run or execute an algorithm (stored in the credit risk score model 226) to determine the creditworthiness of a merchant (e.g., the first merchant 104e or the second merchants 104a-104d).

The data pre-processing engine 218 includes suitable logic and/or interfaces for receiving a loan request from the first merchant 104e. The loan request may be received via an application programming interface (API). The data pre-processing engine 218 is then configured to receive invoice data associated with the first merchant 104e (e.g., new merchant). The invoice data may include information of past invoices and payment transactions performed by the first merchant 104e with other merchants (e.g., the second merchants 104a-104d).

The data pre-processing engine 218 is then configured to identify the supply chain of the first merchant 104e based, at least in part, on the information of past invoices. Further, the data pre-processing engine 218 is configured to select the plurality of second merchants 104a-104d that have interacted with the first merchant 104e in the past. The plurality of second merchants 104a-104d is selected based, at least in part, on the identified supply chain of the first merchant 104e.

In one implementation, the data pre-processing engine 218 is configured to receive historical interaction data associated with the second merchants 104a-104d from a database (e.g., the merchant invoice database 118 or the database 106) for a period of time (e.g., 1 month, 6 months, 1 year, 2 years, etc.). The plurality of second merchants 104a-104d interacts with each other to exchange invoices and/or payment transactions. The historical interaction data may include payment transaction data and business data (e.g., invoice data). The plurality of second merchants 104a-104d may perform business-to-business (B2B) interactions with each other. The data pre-processing engine 218 extracts or accesses the interaction data of interactions performed between the plurality of second merchants 104a-104d.

In an example, the historical interaction data may include historical business data such as the age of the merchant, previous invoices, utility bills, open invoices, existing credit loans, rating of merchant (e.g., the first merchant 104e), the interaction of a merchant with the second merchants 104a-104d, number of employees, and the like. In another example, the historical interaction data may include historical transaction data such as bank statement assessment, Know Your Customer (KYC) information, tax information, corporate account information, loan repayment information, and the like. In yet another example, the historical interaction data may include historical invoice data such as invoice amount, due date, quantity, product level information, payment terms, and the like. In yet another example, the historical interaction data may include information such as customer base, return rate, repeat customer, customer portfolio, and the like.

In an implementation, the historical interaction data may include information about the payment transactions performed among the first merchant 104e and the plurality of second merchants 104a-104d. In another implementation, the historical interaction data may include information about the invoices exchanged among the first merchant 104e and the plurality of second merchants 104a-104d.

In some implementations, the data-preprocessing engine 218 is configured to perform operations (such as data-cleaning, normalization, feature extraction, and the like) on the historical interaction data of the plurality of second merchants 104a-104d and the invoice data of the first merchant 104e. In one non-limiting example, the data pre-processing engine 218 may extract data of historical payment transactions and/or historical business transactions (i.e., invoices exchanged) performed between the first merchant 104e and the plurality of second merchants 104a-104d.

In one implementation, the data pre-processing engine 218 may use natural language processing (NLP) algorithms to extract graphical features associated with the first merchant 104e and its neighborhood (i.e., the plurality of second merchants 104a-104d) based, at least in part, on the historical interaction data (e.g., the historical business data or the invoice data). The graphical features are then used to generate the homogeneous graph. In another implementation, the data pre-processing engine 218 is configured to extract merchant-specific transaction features associated with the first merchant 104e based, at least in part, on the historical transaction data. In yet another implementation, the data pre-processing engine 218 is configured to extract invoice features associated with the first merchant 104e based, at least in part, on the invoice data.

In one implementation, the data pre-processing engine 218 is configured to convert the graphical features into node feature vectors. Further, the data pre-processing engine 218 is configured to convert the transaction features into transaction feature vectors. Furthermore, the data pre-processing engine 218 is configured to convert the invoice features into invoice feature vectors. It is noted that the individual features are converted into their feature vector form. Generally, a feature vector is a vector containing multiple elements about an object.

In some examples, the graphical features include out-degree features capturing the network of a merchant of the plurality of second merchants 104a-104d, out-degree features capturing the dollar amount of transactions with a payment network (e.g., the payment network 112) of the plurality of second merchants 104a-104d, out-degree features capturing on-time payments of a merchant of the plurality of second merchants 104a-104d with the payment network (e.g., the payment network 112), two hops feature capturing the payment network (e.g., the payment network 112) of a merchant of the plurality of second merchants 104a-104d like above-mentioned features, and the like. The graphical features may be utilized by the graph creation engine 220 to generate the homogeneous graph.

It is to be noted that the plurality of second merchants 104a-104d can belong to a single supply chain, and therefore, the graphical features of the plurality of second merchants 104a-104d are used to define a single homogeneous graph corresponding to a specific supply chain. In this manner, one or more homogeneous graphs can be pre-defined for one or more supply chains. For example, a set of merchants (e.g., the plurality of second merchants 104a-104d) interacting in a supply chain can be used to define a homogeneous graph based on the corresponding graphical features of the set of merchants.

The graph creation engine 220 includes suitable logic and/or interfaces for generating the homogeneous graph based, at least in part, on the information of past invoices. Additionally, or alternatively, the graph creation engine 220 is configured to generate the homogeneous graph based, at least in part, on the graphical features or merchant-specific transaction features identified from the historical transaction data. Additionally, or alternatively, the graph creation engine 220 is configured to generate the homogeneous graph based, at least in part, on the invoice features identified from the historical invoice data.

The homogeneous graph represents a computer-based graph representation of the plurality of second merchants 104a-104d as nodes. In addition, interactions/relationships between the nodes are represented as edges (i.e., weighted, or unweighted). In addition, the direction of the edges may represent the flow of a payment transaction, or a business transaction performed between the plurality of second merchants 104a-104d. In an example, if an edge E1 exists between node A and node B and the direction of the edge E1 points from node A towards node B, it represents that a payment transaction or a business transaction (e.g., invoice exchange) has been performed from the node A (e.g., merchant A) to node B (e.g., merchant B). In one embodiment, feature vectors for a particular node may be represented as node feature vectors for a particular node. In an example, the node feature vectors associated with the plurality of second merchants 104a-104d may be generated based on revenue of the merchant, a number of payment transactions performed by the merchant, revenue growth of the merchant, default payments of the merchant, existing credit loans of the merchant, and the like.

In one implementation, the graph creation engine 220 is configured to determine a feature representation of the first merchant 104e based, at least in part, on data features associated with the first merchant 104e in the homogenous graph. In an embodiment, the data features associated with the first merchant 104e include the graphical features and the merchant-specific transaction features associated with the first merchant 104e.

The graphical features include out-degree features capturing network of the first merchant 104e with the plurality of second merchants 104a-104d, out-degree features capturing dollar amount of transactions with network of the plurality of second merchants 104a-104d, out-degree features capturing on-time payments of the first merchant 104e with the plurality of second merchants 104a-104d, and two hop features capturing network of the first merchant 104e with the plurality of second merchants 104a-104d.

The graph creation engine 220 generates the homogeneous graph that associates the first merchant 104e and the plurality of second merchants 104a-104d (i.e., nodes) with each other using one or more relationships (i.e., edges). In one implementation, the graph creation engine 220 is configured to associate the first merchant 104e among the plurality of second merchants 104a-104b using one or more relationships (i.e., edges). It is to be noted that the plurality of second merchants 104a-104d is selected based on their interactions with the first merchant 104e.

For example, the server system 200 identifies the merchants 104a-104e that have interacted with the first merchant 104e in the past based on the invoice data. The graph creation engine 220 is then configured to generate the homogeneous graph based on the information of interactions performed among the first merchant 104e and the plurality of second merchants 104a-104d. In an example, the homogeneous graph may include the nodes (e.g., nodes relating to merchant identifiers) and edges (e.g., edges representing payment transactions or business transactions performed). The homogeneous graph is a node-based structure including the plurality of nodes (representing the merchant node and nodes of the plurality of second merchants 104a-104d) interconnected with each other using edges.

In some embodiments, the homogeneous graph may also include metadata associated with the nodes and/or information identifying the one or more relationships (for example, payment transactions, business transactions, etc.) among the nodes. In addition, the homogeneous graph gets modified or updated with time. For example, each edge of the homogeneous graph represents a payment transaction, or a business transaction performed between the merchant 104a and the merchant 104c.

In some non-limiting examples, the invoice features of the first merchant 104e include features based on invoice amount, utility bills, open invoices, the age of the first merchant 104e, tax information associated with the first merchant 104e, and the like. In some non-limiting examples, the graphical features of the second merchants 104a-104d include features based on revenue of the second merchants 104a-104d, number of transactions performed via the second merchants 104a-104d, revenue growth of the second merchants 104a-104d, default payment of the second merchants 104a-104d, and the like.

In some examples, the invoice features of the first merchant 104e are associated or linked with the graphical features of the second merchants 104a-104d to generate a homogeneous graph. In one embodiment, the homogeneous graph is generated based, at least in part, on a neighborhood aggregation algorithm. It is noted that the graphical features facilitate the server system 200 to capture common merchant characteristics, the invoice features facilitate the server system 200 to analyze the merchant's relationship with other merchants, and the feature vectors (or graph embeddings) facilitate the server system 200 to capture reliability and/or strength of merchant's business.

In one example, the graph creation engine 220 is configured to define the merchant node based, at least in part, on the invoice data. It is noted that the merchant node is defined in the same manner as nodes are defined in the homogeneous graph. For example, the merchant node is defined based on the invoice data associated with the first merchant 104e. The graph creation engine 220 is then configured to associate the merchant node with other nodes in the homogenous graph.

It is noted that the plurality of second merchants 104a-104d may be selected based on their interactions with the first merchant 104e. For example, the plurality of second merchants 104a-104d may include merchants that have directly interacted with the first merchant 104e in the past and/or merchants that have indirectly interacted with the first merchant 104e in the past. In this manner, the server system 200 utilizes information from the direct and indirect neighboring nodes of the merchant node to generate the credit risk score for the first merchant 104e.

The credit risk score engine 222 includes suitable logic and/or interfaces for determining the creditworthiness of the first merchant 104e. In an embodiment, the first merchant 104e may correspond to a new merchant that belongs to a similar supply chain as that of the second merchants 104a-104d. In another embodiment, the first merchant 104e may correspond to an existing merchant that belongs to the second merchants 104a-104d. More specifically, the credit risk score engine 222 is configured to calculate a credit risk score for the first merchant 104e. The credit risk score is indicative of the likelihood that the first merchant 104e will default in the future.

In one implementation, the credit risk score engine 222 is configured to process or analyze the homogeneous graph. In one implementation, the credit risk score engine 222 is configured to apply a nearest neighborhood aggregation algorithm to extract information from neighboring nodes of the merchant node. In an example, for the merchant node, the credit risk score engine 222 is configured to extract information from its neighboring nodes. In some implementations, the credit risk score engine 222 is configured to extract information from one-hop neighboring nodes, two-hop neighboring nodes, three-hop neighboring nodes, and so on for the merchant node.

In an embodiment, the credit risk score engine 222 is configured to calculate the first credit risk score for the first merchant 104e based at least on the graphical features associated with the plurality of second merchants 104a-104d. The graphical features are extracted from the homogeneous graph. The “first credit risk score” herein represents the likelihood whether the first merchant 104e will default in the future. Additionally, or alternatively, the credit risk score engine 222 is configured to calculate the second credit risk score for the first merchant 104e based at least on the invoice features associated with the first merchant 104e. The invoice features are extracted based, at least in part, on the invoice data of the first merchant 104e.

For example, the first merchant 104e may have sold products (e.g., goods, services, etc.) to 10 other entities or merchants till now, and therefore, have 10 invoices as the past invoice data. Therefore, the credit risk score engine 222 is configured to calculate the second credit risk score for the first merchant 104e based at least on data of the past 10 invoices.

The “second credit risk score” herein also represents a likelihood that the first merchant 104e will default in the future. The credit risk score engine 222 is further configured to calculate the credit risk score (i.e., final credit risk score) for the first merchant 104e based, at least in part, on the first credit risk score and the second credit risk score. More specifically, the credit risk score engine 222 is configured to calculate the credit risk score based, at least in part, on the implementation of the machine learning model (i.e., the credit risk score model 226).

The “credit risk score” herein represents a final credit risk score indicating an outcome or likelihood of whether the first merchant 104e can default in the future. The credit risk score is treated as the final output based on which the credit loan provider 120 decides whether to provide the credit loan to the first merchant 104e. The credit risk score is indicative of the creditworthiness of the first merchant 104e. In one implementation, the credit risk score is a weighted average of the first credit risk score and the second credit risk score.

In one non-limiting example, the credit risk score model 226 is a classifier model (e.g., two-class classifier model). In another non-limiting example, the credit risk score model 226 is a k-nearest neighbor (KNN) model. The KNN model utilizes a k-nearest neighbors algorithm to perform pattern recognition tasks. In other words, the KNN model is utilized to extract information from the plurality of nodes (i.e., the plurality of second merchants 104a-104d) in the homogeneous graph.

In an embodiment, the credit risk score is a probability value between 0 to 100 indicating a percentage of probability that the first merchant 104e can default in the future. For example, a credit risk score of 25 represents that there is a 25% probability that the first merchant 104e can default in the future. In another example, the credit risk score of 89 represents that there is an 89% probability that the first merchant 104e can default in the future. Further, the credit loan provider 120 may set up a threshold probability value above which the first merchant 104e can be considered a risky merchant for the credit loan provider 120.

For example, the credit loan provider 120 sets 75 as the threshold probability value. If the credit risk score for a merchant A is greater than or equal to 75, then the merchant A will be considered as vulnerable or risky and thus can default in the future. Otherwise, if the credit risk score for a merchant B is less than 75, then the merchant B will not be considered as vulnerable or risky and thus shall not default in the future.

In another embodiment, the credit risk score is a binary value of either 0 or 1. In an example, value 0 indicates that the first merchant 104e shall not default in the future, and value 1 indicates that the first merchant 104e can default in the future. In one embodiment, the credit risk score model 226 is configured to convert the probability value into the binary value. For example, if the credit risk score is calculated as a value in the range of 0 to 50, the credit risk score can be treated as a binary value of 0. Otherwise, if the credit risk score is calculated as a value in the range of 51 to 100, the credit risk score can be treated as a binary value of 1.

The notification engine 224 includes suitable logic and/or interfaces for transmitting a notification to the credit loan provider 120. The notification includes the credit risk score of the first merchant 104e. The notification engine 224 is configured to notify the credit loan provider 120 with the credit risk score of the first merchant 104e. In addition, the notification may include a recommendation on whether the credit loan provider 120 should provide the credit loan to the first merchant 104e. In some non-limiting examples, the notification engine 224 may transmit the credit risk score as push notifications, text messages, alerts, multi-media messages, flash messages, and the like.

The credit loan provider 120 may receive the credit risk score for the first merchant 104e from the notification engine 224. Based on the credit risk score of the first merchant 104e, the credit loan provider 120 can decide whether to approve or decline the credit loan request of the first merchant 104e.

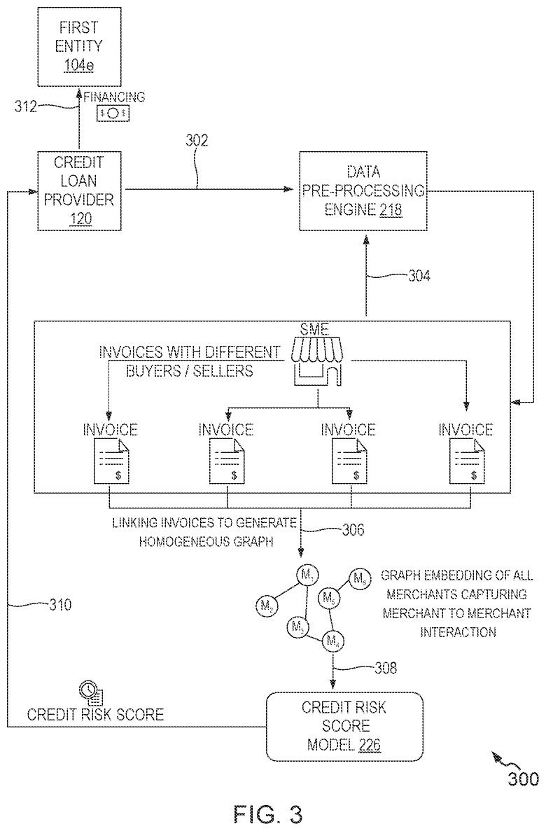

FIG. 3 is an example representation 300 of communication data flow to determine the creditworthiness of the first merchant 104e, in accordance with an embodiment of the present disclosure.

Initially, the server system 200 may receive a request to determine the creditworthiness of a merchant (e.g., the first merchant 104e). The server system 200 may receive the request from the credit loan provider 120. More specifically, the credit loan provider 120 may send a request to the server system 200 to determine the creditworthiness of the first merchant 104e via an application programming interface (API). Generally, API is a medium that enables two or more computer programs to communicate with each other. In particular, the data pre-processing engine 218 may receive the request from the credit loan provider 120 (see, 302).

The data pre-processing engine 218 is configured to access the invoice data of the first merchant 104e (see, 304). In one implementation, the invoice data includes past invoices generated by the first merchant 104e over a period of time (e.g., since the inception of the first merchant 104e). The invoice data may include invoice amount, due date, quantity, payment terms, product level information, and the like for various invoices generated by the first merchant 104e.

In other words, the processor 206 is configured to receive past invoices of the first merchant 104e. In one example, the invoices may be manually uploaded. In another example, the invoices may be stored in the merchant invoice database 118. In yet another example, the invoices may be accessed from cloud storage.

The processor 206 is then configured to identify the supply chain of the first merchant 104e based, at least in part, on the invoice data. The server system 200 is further configured to select the plurality of second merchants 104a-104d based on the identified supply chain of the first merchant 104e. The processor 206 is further configured to define the homogeneous graph based on the interactions among the first merchant 104e and the plurality of second merchants 104a-104d. The plurality of second merchants 104a-104d may include the merchants that have interacted with the first merchant 104e in the past. It is to be noted that the supply chain of the plurality of second merchants 104a-104d is identical to the supply chain of the first merchant 104e.

In one example, the processor 206 is configured to associate the invoice data (i.e., past invoices) of the first merchant 104e with the plurality of second merchants 104a-104d to generate the homogeneous graph (see, 306).

In one implementation, the homogeneous graph includes embeddings of the second merchants 104a-104d (e.g., buyers, sellers, etc.) and the first merchant 104e. Moreover, the processor 206 is configured to generate the homogeneous graph based, at least in part, on a neighborhood aggregation algorithm. The processor 206 may utilize the neighborhood aggregation algorithm to retrieve information from one-hop, two-hop, or three-hop neighboring nodes of the merchant node in the homogeneous graph.

Moreover, the processor 206 is configured to pass the homogeneous graph as an input to the credit risk score model 226 (see, 308). The credit risk score model 226 is configured to process the homogeneous graph to calculate the credit risk score for the first merchant 104e. For example, the credit risk score is determined based on the relationship of the first merchant 104e with the second merchants 104a-104d in the supply chain. It is to be noted that the homogeneous graph includes the invoices of the first merchant 104e with other merchants (e.g., the second merchants 104a-104d), and therefore, the homogeneous graph has information about the transactions performed between the first merchant 104e and other merchants. The server system 200 is configured to utilize this information or intelligence to calculate the credit risk score for the first merchant 104e.

The processor 206 is also configured to transmit the credit risk score to the credit loan provider 120 (see, 310). In some implementations, the processor 206 is configured to transmit the credit risk score via push notifications, alerts, reminders, text messages, third-party messages, and the like. The credit loan provider 120 utilizes the credit risk score to determine the creditworthiness of the first merchant 104e (as explained above in FIG. 2). In case of credit loan approval, the credit loan provider 120 may disburse the credit loan amount to a payment account of the first merchant 104e (see, 312). More specifically, funds equal to the credit loan amount are debited from a payment account of the credit loan provider 120 and credited in a payment account of the first merchant 104e.

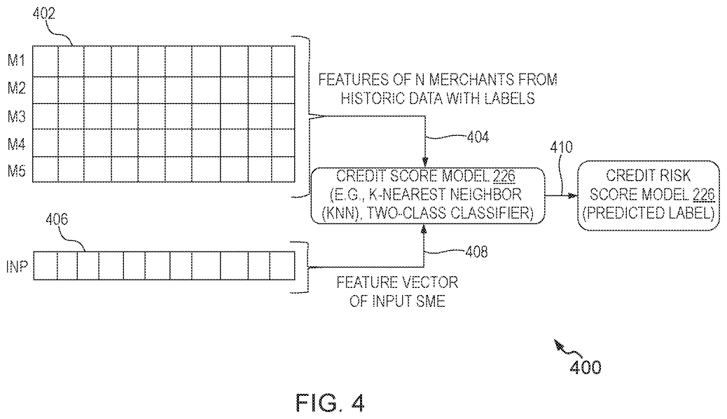

FIG. 4 is a block diagram representation 400 of the calculation of a first credit risk score from graphical features, in accordance with an embodiment of the present disclosure.

As explained above, the processor 206 is configured to generate the graphical features for the plurality of second merchants 104a-104d. With reference to the homogenous graph, the plurality of second merchants 104a-104d may include direct neighboring nodes of the merchant node (merchants that directly interacted with the first merchant 104e) and indirect neighboring nodes of the merchant node (merchants that indirectly interacted with the first merchant 104e (e.g., two-hop neighbors)).

In one implementation, the graphical features for the direct neighboring nodes of the merchant node may be represented in the form of a matrix (see, 402). In one implementation, the graphical features for each merchant may be represented as rows in the matrix. With reference to 402, M1, M2, M3, M4, and M5 represent five different merchants (i.e., direct neighboring nodes of the merchant node) along with their graphical features.

The processor 206 is further configured to input the graphical features into the credit risk score model 226 (see, 404). In an embodiment, the credit risk score model 226 is a two-class classifier model. In another embodiment, the credit risk score model 226 is a k-nearest neighbor (KNN) model. Generally, the KNN model is configured to classify data points based on the data points that are most similar to it.

The processor 206 is also configured to input a feature vector (see, 406) of the first merchant 104e to the credit risk score model 226. The feature vector of the first merchant 104e is generated based on the invoice features identified from the invoice data of the first merchant 104e. With reference to 406, INP represents the feature vector of the first merchant 104e (e.g., new merchant or existing merchant) along with its invoice features. Moreover, the processor 206 is configured to input the feature vector of the first merchant 104e to the credit risk score model 226 (see, 408).

The processor 206 is then configured to run or implement the credit risk score model 226 to compute the credit risk score for the first merchant 104e (see, 410). In one implementation, the processor 206 is configured to utilize the graphical features of the direct neighboring merchants and the invoice features of the first merchant 104e to calculate the credit risk score for the first merchant 104e.

In one example, the processor 206 is configured to utilize the graphical features to calculate the first credit risk score, and the invoice features to calculate the second credit risk score. In addition, the processor 206 is configured to calculate the credit risk score based, at least in part, on the first credit risk score and the second credit risk score. In one implementation, the credit risk score is a weighted average of the first credit risk score and the second credit risk score. The credit risk score facilitates the credit loan provider 120 to determine the creditworthiness of the first merchant 104e.

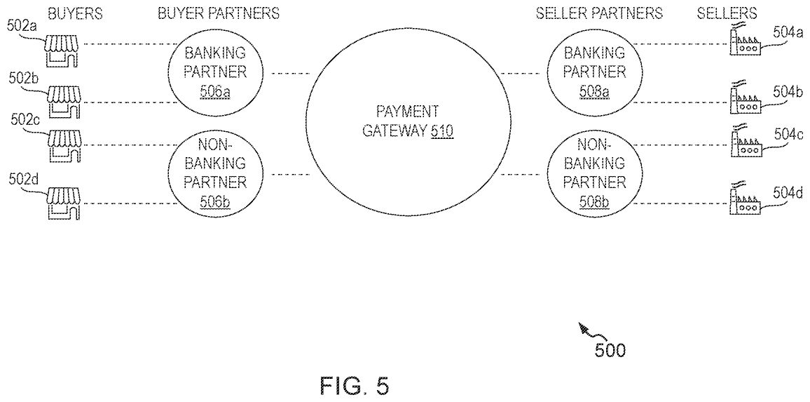

FIG. 5 is a block diagram representation 500 of data exchanges between the plurality of second merchants 104a-104d, in accordance with an embodiment of the present disclosure.

As explained above, the plurality of second merchants 104a-104d interacts with each other to perform invoice exchange and/or monetary value exchange (i.e., payment transactions). For example, the second merchant 104a may interact with the second merchant 104c. With reference to FIG. 5, merchants 502a, 502b, 502c, and 502d may correspond to buyers and merchants 504a, 504b, 504c, and 504d may correspond to sellers. The merchants 502a-502d and the merchants 504a-504d are identical to the merchants 104a-104b of FIG. 1

In one example, the merchants 502a-502b are associated with a banking partner 506a and the merchants 502c-502d are associated with a non-banking partner 506b. The banking partner 506a and the non-banking partner 506b are associated with the buyers (i.e., the merchants 502a-502d).

In one example, the merchants 504a-504b are associated with a banking partner 508a, and the merchants 504c-504d are associated with a non-banking partner 508b. The banking partner 508a and the non-banking partner 508b are associated with the sellers (i.e., the merchants 504a-504d).

The banking partner 506a and the non-banking partner 506b may interact or transact with the banking partner 508a and the non-banking partner 508b via a payment gateway 510. The payment gateway 510 is identical to the payment gateway 126 of FIG. 1. In one implementation, the payment gateway 510 enables business-to-business (B2B) payment transactions and/or business transactions (e.g., invoice exchange, etc.) between the buyers and the sellers. In one implementation, the payment gateway 510 enables the sellers to exchange invoices with the buyers via the payment gateway 510.

In some embodiments, the payment gateway 510 supports different payment types such as card payments, automated clearing house (ACH) payments, real-time payments (RTP), Account-to-Account (A2A) payments, cross-border payments, and the like.

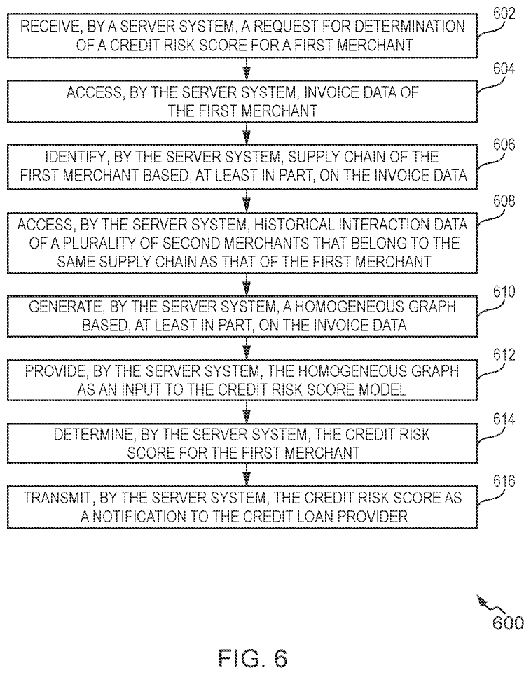

FIG. 6 represents a flow chart 600 of a method for determining the creditworthiness of the first merchant 104e, in accordance with an embodiment of the present disclosure. The sequence of operations of the flow chart 600 may not be necessarily executed in the same order as they are presented. Further, one or more operations may be grouped and performed in form of a single step, or one operation may have several sub-steps that may be performed in parallel or in a sequential manner. It is to be noted that to explain the flow chart 600, references may be made to elements described in FIG. 1 and FIG. 2.

At 602, the server system 200 receives a request for determination of the credit risk score for a merchant (e.g., the first merchant 104e). The first merchant 104e may suffer from a problem of data deficiency i.e., the first merchant 104e may not have sufficient data to compute its credit risk score, thereby, making it difficult for the credit loan provider 120 to determine the creditworthiness of the first merchant 104e. The first merchant 104e may correspond to an SME, and the like.

At 604, the server system 200 receives or accesses the invoice data of the first merchant 104e. The invoice data may include information of past invoices generated by the first merchant 104e. In some examples, the invoice data may include invoice amount, quantity, invoice date, the due date of payment, payment terms, product level information, and the like corresponding to each invoice of the plurality of invoices generated by the first merchant 104e.

At 606, the server system 200 identifies the supply chain of the first merchant 104e based, at least in part, on the invoice data.

At 608, the server system 200 accesses historical interaction data of the plurality of second merchants 104a-104d that belong to the same supply chain as that of the first merchant 104e. The historical interaction data may include interactions performed between the plurality of second merchants 104a-104d. In an embodiment, the historical interaction data includes historical invoice data of invoices exchanged between the plurality of second merchants 104a-104d. In another embodiment, the historical interaction data includes historical transaction data of payment transactions performed between the plurality of second merchants 104a-104d.

At 610, the server system 200 generates a homogeneous graph based, at least in part, on the invoice data. The homogeneous graph corresponds to a computer-implemented graph representation of the first merchant 104e and the plurality of second merchants 104a-104d as the plurality of nodes and the edges may represent the interactions performed among the first merchant 104e and the plurality of second merchants 104a-104d.

In one implementation, the homogenous graph includes the embeddings of the first merchant 104e and the plurality of second merchants 104a-104d. In one implementation, the homogeneous graph is generated based, at least in part, on the neighborhood aggregation algorithm.

At 612, the server system 200 provides the homogeneous graph as an input to the machine learning model (i.e., the credit risk score model 226).

At 614, the server system 200 determines the credit risk score for the first merchant 104e. More specifically, the server system 200 utilizes the information of merchant-to-merchant interaction in the homogeneous graph along with the invoices of the first merchant 104e to determine the past transaction behavior of the first merchant 104e with other merchants. More specifically, the server system 200 utilizes the graphical features of the homogeneous graph along with the invoice features of the first merchant 104e to calculate the credit risk score for the first merchant 104e.

At 616, the server system 200 transmits the credit risk score as a notification to the credit loan provider 120. The credit loan provider 120 may then decide to approve or disapprove a credit loan request of the first merchant 104e based on the calculated credit risk score.

The sequence of steps of the flow chart 600 need not be necessarily executed in the same order as they are presented. Further, one or more operations may be grouped together and performed in form of a single step, or one operation may have several sub-steps that may be performed in parallel or in a sequential manner.

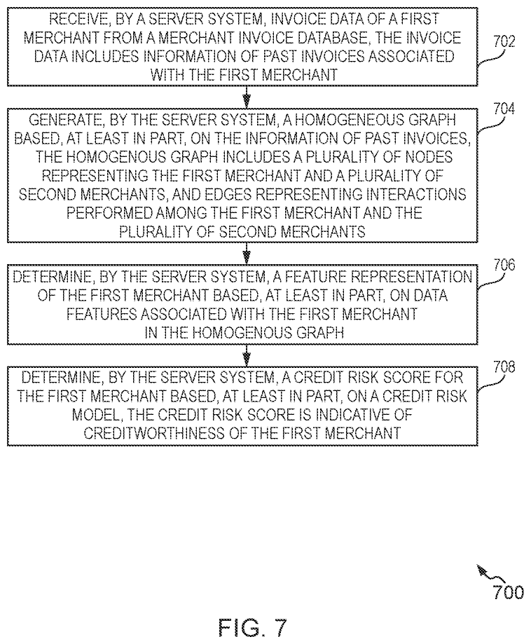

FIG. 7 illustrates a flow diagram depicting a method 700 for calculating the credit risk score for the first merchant 104e, in accordance with an embodiment of the present disclosure. The method 700 depicted in the flow diagram may be executed by, for example, the server system 200. Operations of the method 700, and combinations of operation in the method 700, may be implemented by, for example, hardware, firmware, a processor, circuitry, and/or a different device associated with the execution of software that includes one or more computer program instructions. The operations of the method 700 described herein may be performed by an application interface that is hosted and managed with help of the server system 200. The method 700 starts at operation 702.

At operation 702, the method 700 includes receiving, by the server system 200, invoice data of the first merchant 104e from the merchant invoice database 118. The invoice data includes information of past invoices associated with the first merchant 104e.

At operation 704, the method 700 includes generating, by the server system 200, the homogeneous graph based, at least in part, on the information of past invoices. The homogenous graph includes the plurality of nodes representing the first merchant 104e and the plurality of second merchants 104a-104d, and edges representing interactions performed among the first merchant 104e and the plurality of second merchants 104a-104d.

At operation 706, the method 700 includes determining, by the server system 200, the feature representation of the first merchant 104e based, at least in part, on data features associated with the first merchant 104e in the homogenous graph.

At operation 708, the method 700 includes determining, by the server system 200, the credit risk score for the first merchant 104e based, at least in part, on the credit risk model. The credit risk score is indicative of the creditworthiness of the first merchant 104e.

The sequence of operations of the method 700 need not be necessarily executed in the same order as they are presented. Further, one or more operations may be grouped together and performed in form of a single step, or one operation may have several sub-steps that may be performed in parallel or in a sequential manner.

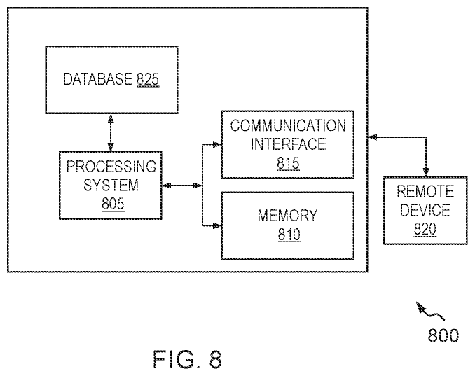

FIG. 8 is a simplified block diagram of a payment server 800, in accordance with an embodiment of the present disclosure. The payment server 800 is an example of the payment server 114 of FIG. 1. The payment server 800 and the server system 200 may use the payment network 112 as a payment interchange network. Examples of payment interchange networks include, but are not limited to, Mastercard® payment system interchange network.

The payment server 800 includes a processing system 805 configured to extract programming instructions from a memory 810 to provide various features of the present disclosure. The components of the payment server 800 provided herein may not be exhaustive and the payment server 800 may include more or fewer components than those depicted in FIG. 8. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication interface 815, the processing system 805 receives a request from a remote device 820, such as the issuer server 124 or the acquirer server 122. The request may be a request for conducting the payment transaction. The communication may be achieved through API calls, without loss of generality. The payment server 800 includes a database 825. The database 825 also includes transaction processing data such as issuer ID, country code, acquirer ID, and merchant identifier (MID), among others.

When the payment server 800 receives a payment transaction request from the acquirer server 122 or a payment terminal (e.g., point of sale (POS) device, etc.), the payment server 800 may route the payment transaction request to an issuer server (e.g., the issuer server 124). The database 825 stores transaction identifiers for identifying transaction details such as transaction amount, payment card details, acquirer account information, transaction records, merchant account information, and the like.

In one example embodiment, the acquirer server 122 is configured to send an authorization request message to the payment server 800. The authorization request message includes, but is not limited to, the payment transaction request.

The processing system 805 further sends the payment transaction request to the issuer server 124 for facilitating the payment transactions from the remote device 820. The processing system 805 is further configured to notify the remote device 820 of the transaction status in form of an authorization response message via the communication interface 815. The authorization response message includes, but is not limited to, a payment transaction response received from the issuer server 124. Alternatively, in one embodiment, the processing system 805 is configured to send an authorization response message for declining the payment transaction request, via the communication interface 815, to the acquirer server 122.

Without limiting the scope of the present disclosure, the one or more example embodiments disclosed herein provide methods and systems for determining the creditworthiness of a first merchant. More specifically, invoice data of the first merchant is received from a merchant invoice database. The invoice data includes information of past invoices associated with the first merchant. In addition, a homogeneous graph is generated based, at least in part, on the information of past invoices. The homogenous graph includes a plurality of nodes representing the first merchant and a plurality of second merchants and edges representing interactions performed among the first merchant and the plurality of second merchants. Further, a feature representation of the first merchant is determined based, at least in part, on data features associated with the first merchant in the homogenous graph. Furthermore, a credit risk score is determined for the first merchant based, at least in part, on a credit risk score model.

The disclosed methods with reference to FIGS. 1 to 8, or one or more operations of the methods 600 and 700 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (e.g., the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for predicting creditworthiness of merchants, the computer-implemented method comprising:
receiving, by a server system, invoice data of a first merchant from a merchant invoice database, the invoice data comprising information of past invoices associated with the first merchant;
generating, by the server system, a homogeneous graph based, at least in part, on the information of past invoices, the homogenous graph comprising a plurality of nodes representing the first merchant and a plurality of second merchants and edges representing interactions performed among the first merchant and the plurality of second merchants;
determining, by the server system, a feature representation of the first merchant based, at least in part, on data features associated with the first merchant in the homogenous graph; and
determining, by the server system, a credit risk score for the first merchant based, at least in part, on a credit risk model, the credit risk score indicative of the creditworthiness of the first merchant.

2. The computer-implemented method as claimed in claim 1, wherein the first merchant belongs to a supply chain out of one or more supply chains.

3. The computer-implemented method as claimed in claim 2, further comprising:
identifying, by the server system, the supply chain of the first merchant based, at least in part, on the information of past invoices; and
selecting, by the server system, the plurality of second merchants that have interacted with the first merchant, the plurality of second merchants selected based, at least in part, on the identified supply chain of the first merchant.

4. The computer-implemented method as claimed in claim 1, wherein the credit risk model is a classification model.

5. The computer-implemented method as claimed in claim 1, wherein the data features associated with the first merchant comprise graphical features and merchant-specific transaction features associated with the first merchant.

6. The computer-implemented method as claimed in claim 5, wherein the graphical features comprise out-degree features capturing network of the first merchant with the plurality of second merchants, out-degree features capturing dollar amount of transactions with network of the plurality of second merchants, out-degree features capturing on-time payments of the first merchant with the plurality of second merchants, and two hop features capturing network of the first merchant with the plurality of second merchants.

7. The computer-implemented method as claimed in claim 1, further comprising:
receiving, by the server system, a loan request from the first merchant, the loan request received via an application programming interface (API).

8. The computer-implemented method as claimed in claim 7, further comprising:
implementing, by the server system, the credit risk model for determining the credit risk score for the first merchant.

9. The computer-implemented method as claimed in claim 1, further comprising:
transmitting, by the server system, a notification to a credit loan provider, the notification comprising the credit risk score of the first merchant.

10. A server system for predicting creditworthiness of merchants, the server system comprising:
a memory; and
a processor programmed to:
receive, by a server system, invoice data of a first merchant from a merchant invoice database, the invoice data comprising information of past invoices associated with the first merchant;
generate, by the server system, a homogeneous graph based, at least in part, on the information of past invoices, the homogenous graph comprising a plurality of nodes representing the first merchant and a plurality of second merchants and edges representing interactions performed among the first merchant and the plurality of second merchants;
determine, by the server system, a feature representation of the first merchant based, at least in part, on data features associated with the first merchant in the homogenous graph; and
determine, by the server system, a credit risk score for the first merchant based, at least in part, on a credit risk model, the credit risk score indicative of the creditworthiness of the first merchant.

11. The server system as claimed in claim 10, wherein the first merchant belongs to a supply chain out of one or more supply chains.

12. The server system as claimed in claim 11, wherein the processor is further programmed to:
identify, by the server system, the supply chain of the first merchant based, at least in part, on the information of past invoices; and
select, by the server system, the plurality of second merchants that have interacted with the first merchant, the plurality of second merchants selected based, at least in part, on the identified supply chain of the first merchant.

13. The server system as claimed in claim 1, wherein the credit risk model is a classification model.

14. The server system as claimed in claim 1, wherein the data features associated with the first merchant comprise graphical features and merchant-specific transaction features associated with the first merchant.

15. The server system as claimed in claim 14, wherein the graphical features comprise out-degree features capturing network of the first merchant with the plurality of second merchants, out-degree features capturing dollar amount of transactions with network of the plurality of second merchants, out-degree features capturing on-time payments of the first merchant with the plurality of second merchants, and two hop features capturing network of the first merchant with the plurality of second merchants.

16. The server system as claimed in claim 1, wherein the processor is further programmed to:
receive, by the server system, a loan request from the first merchant, the loan request received via an application programming interface (API).

17. The server system as claimed in claim 16, wherein the processor is further programmed to:
implement, by the server system, the credit risk model for determining the credit risk score for the first merchant.

18. The server system as claimed in claim 1, wherein the processor is further programmed to:
transmit, by the server system, a notification to a credit loan provider, the notification comprising the credit risk score of the first merchant.
